(19) United States
(12) Patent Application Publication
(10) Pub. No.: US 2026/0087604 A1
(43) Pub. Date: Mar. 26, 2026

(54) IMAGE PROCESSING APPARATUS CONNECTABLE TO DISPLAY DEVICE, DISPLAY DEVICE, CONTROL METHOD FOR IMAGE PROCESSING APPARATUS, AND STORAGE MEDIUM STORING CONTROL PROGRAM FOR IMAGE PROCESSING APPARATUS

(71) Applicant: CANON KABUSHIKI KAISHA, Tokyo (JP)

(72) Inventor: WAKAKI HATTORI, Tokyo (JP)

(21) Appl. No.: 19/316,084

(22) Filed: Sep. 2, 2025

(30) Foreign Application Priority Data
Sep. 25, 2024 (JP) 2024-166161

(51) Int. Cl. G06T 5/80; H04N 13/122; H04N 13/332

(52) U.S. Cl. CPC G06T 5/80; H04N 13/122; G06T 2207/10012; H04N 13/332

(57) ABSTRACT

An image processing apparatus that can complete an image process with a frame rate at a time of streaming. The image processing apparatus is communicably connected to a display device that displays a left eye image viewable by a left eye and a right eye image viewable by a right eye. The image processing apparatus includes a memory device that stores instructions and a processor that executes the instructions to obtain a fisheye image that is a moving image captured using a fisheye lens, perform an image process to reduce a distortion on one image between a left eye image and a right eye image in a case where the fisheye image includes the left eye image and the right eye image, and perform the image process on another image in a case where the image process for the one image is completed within a predetermined time period.

### BACKGROUND

### Field of the Technology

The aspect of the embodiments relates to an image processing apparatus connectable to a display device, the display device, a control method for the image processing apparatus, and a storage medium storing a control program for the image processing apparatus.

### Description of the Related Art

Spread of the Internet has enabled live streaming of a moving image in real time. Further, a camera on which two fisheye lenses are mounted at left and right is known. A fisheye lens has a field angle of 180 degrees. This camera can capture a moving image of VR180. The “VR180” is a standard for stereoscopically viewing a VR moving image of which the field angle is 180 degrees. When the VR180 moving image is VR live streamed in real time using this camera, it is necessary to convert a fisheye moving image obtained through each fisheye lens into a moving image in an equirectangular projection format in real time in accordance with a frame rate at the time of streaming.

The VR180 moving image is streamed to a head-mounted display and displayed in a stereoscopically visible manner. When the VR180 moving image displayed on the head-mounted display is visually recognized, parallax between left and right images is corrected. Since the correction uses meta information of the camera and lens, for example, this correction tends to be performed by the streaming source of the VR180 moving image. Japanese Patent Laid Open No. 2012-100256 (JP2012-100256A) discloses a system having an apparatus that divides one screen and transmits an image for a left eye and an image for a right eye in performing 3D broadcasting and an apparatus that displays the respective images alternately in time.

However, the system described in the above publication may not complete the image processes for the image for the left eye and the image for the right eye with the frame rate at the time of streaming, when the VR180 moving image is VR live streamed in real time.

### SUMMARY

The present disclosure provides an image processing apparatus, a display device, a control method for the image processing apparatus, and a storage medium storing a control program, which can complete an image process with a frame rate at a time of streaming.

Accordingly, an aspect of the embodiments provides an image processing apparatus communicably connected to a display device that displays a left eye image viewable by a left eye and a right eye image viewable by a right eye. The image processing apparatus includes a memory device that stores a set of instructions, and at least one processor that executes the set of instructions to obtain a fisheye image that is a moving image captured using a fisheye lens, perform an image process to reduce a distortion on one image between a left eye image and a right eye image in a case where the fisheye image includes the left eye image and the right eye image, and perform the image process on another image in a case where the image process for the one image is completed within a predetermined time period.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram illustrating an example of an overall configuration of an image processing system.

FIG. 2 is a block diagram illustrating an example of a hardware configuration of an image processing apparatus.

FIG. 3 is a flowchart illustrating a process executed by the image processing apparatus.

FIG. 4A is a view for describing processes in steps S305 and S309 in the flowchart shown in FIG. 3.

FIG. 4B is a view for describing processes in steps S308 and S310 in the flowchart shown in FIG. 3.

FIG. 5 is a flowchart illustrating a process executed by an HMD.

FIG. 6A is a view for describing a process in a step S503 in the flowchart shown in FIG. 5.

FIG. 6B is a view for describing a process in a step S505 in the flowchart shown in FIG. 5.

### DESCRIPTION OF THE EMBODIMENTS

Hereinafter, an embodiment of the present disclosure will be described in detail with reference to the attached drawings. However, the configuration described in the following embodiment is merely an example, and the scope of the present disclosure is not limited by the configuration described in the embodiment. For example, each of the units constituting the present disclosure can be replaced with any unit that can exhibit the same function. In addition, an arbitrary constituent may be added.

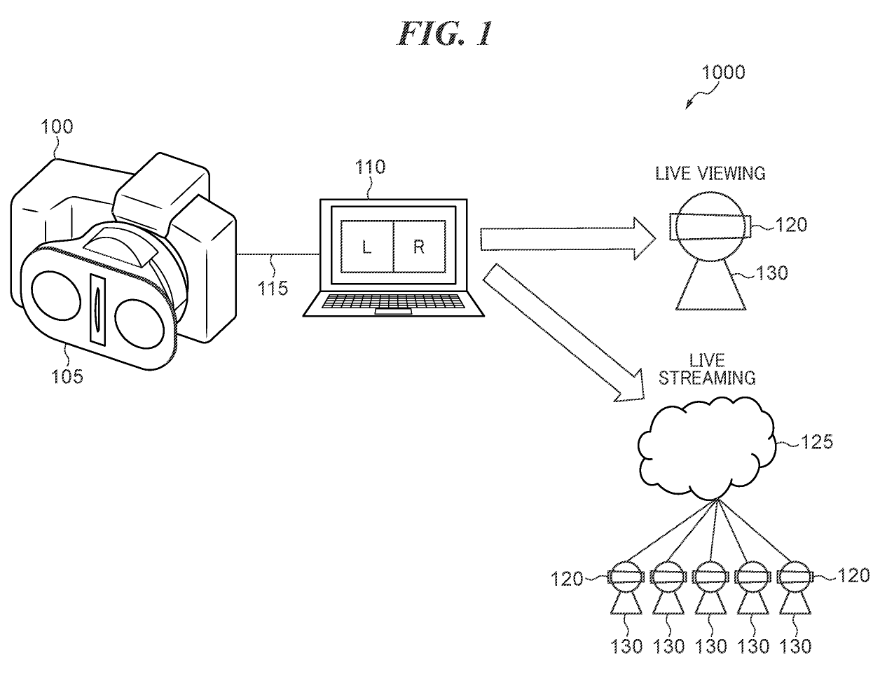

FIG. 1 is a schematic configuration diagram illustrating an example of an overall configuration of an image processing system. As illustrated in FIG. 1, the image processing system (an information processing system) 1000 includes a digital camera 100, an image processing apparatus 110, and an HMD (Head Mounted Display) 120. A lens unit 105 is detachably mounted on the digital camera 100. The lens unit 105 is a dual fisheye lens (VR180 lens) unit having two fisheye lenses. The digital camera 100 can capture a still image or a moving image as a dual fisheye image (a circular fisheye image) having parallax with the lens unit 105.

In the present embodiment, a moving image is a processing target in the image processing apparatus 110. The dual fisheye image includes a left eye image (left-eye circular fisheye image) viewable by a left eye of a user 130 wearing the HMD 120 and a right eye image (right-eye circular fisheye image) viewable by a right eye of the user 130. The image processing apparatus 110 is communicably coupled to the digital camera 100 via an HDMI (registered trademark) cable 115. Accordingly, the image processing apparatus 110 can obtain the dual fisheye image captured by the digital camera 100 (an obtaining step). Then, the image processing apparatus 110 can perform an image process to reduce a distortion on the dual fisheye image, and can output a right eye image and a left eye image of which distortions have been reduced by the image process to the HMD 120.

The image processing apparatus 110 is not particularly limited, and for example, a desktop or notebook personal computer, a tablet terminal, a smartphone, or the like may be used. In addition, the digital camera 100 and the image processing apparatus 110 are configured separately from each other in the configuration illustrated in FIG. 1, but this is not limited. They may be integrally configured, for example, that is, may be configured such that the function of the image processing apparatus 110 is incorporated in the digital camera 100.

The HMD 120 is communicably coupled to the image processing apparatus 110. Accordingly, the user 130 can appreciate the dual fisheye image obtained by performing the image process in the image processing apparatus 110 while wearing the HMD 120 on a head. In this case, the image processing apparatus 110 converts the dual fisheye image into a format suitable for streaming, and directly transmits the dual fisheye image to the HMD 120, or distributes the dual fisheye image to HMDs 120 of users 130 via a cloud 125. Note that a communication method between the HMD 120 and the image processing apparatus 110 is not particularly limited, and may be, for example, a wireless communication method or a wired communication method.

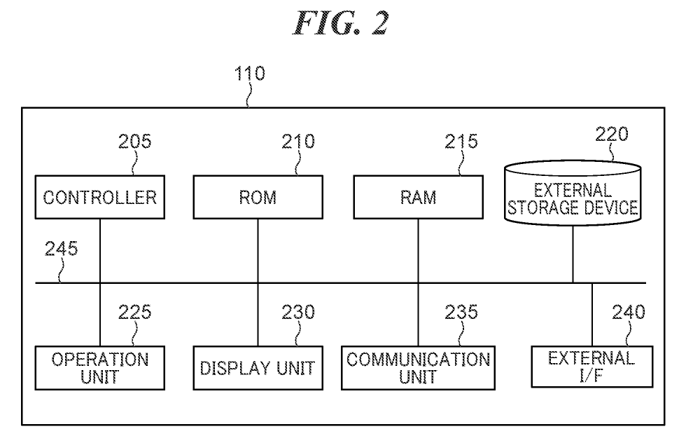

FIG. 2 is a block diagram illustrating an example of a hardware configuration of the image processing apparatus. As illustrated in FIG. 2, the image processing apparatus 110 includes a controller 205, a ROM 210, a RAM 215, an external storage device 220, an operation unit 225, a display unit 230, a communication unit 235, and an external I/F 240, which are communicably connected to each other via a system bus 245.

The controller 205 is a computer that includes, for example, a CPU and controls the entire image processing apparatus 110. The ROM 210 stores programs, parameters, etc. The programs include, for example, a program that causes the controller 205 to execute steps (a control method for the image processing apparatus) described later. The RAM 215 temporarily stores programs, data, etc. supplied from an external apparatus.

The external storage device 220 stores various programs, data, etc. The external storage device 220 is not particularly limited, and for example, may be a hard disk or a flash memory fixedly installed in the image processing apparatus 110, or an FD or an optical disk such as a CD detachably installed in the image processing apparatus 110. The external storage device 220 may be a magnetic card, an optical card, an IC card, a memory card, or the like. The operation unit 225 includes a button, a touch panel, or the like that accepts a user operation and inputs data.

The display unit 230 displays, for example, data stored in the image processing apparatus 110. The display unit 230 is not particularly limited, and for example, may be a liquid crystal display. The communication unit 235 is connected to the Internet or the like. The external I/F 240 may receive a dual fisheye image from the digital camera 100. The external I/F 240 can transmit data stored in the image processing apparatus 110 to an external apparatus.

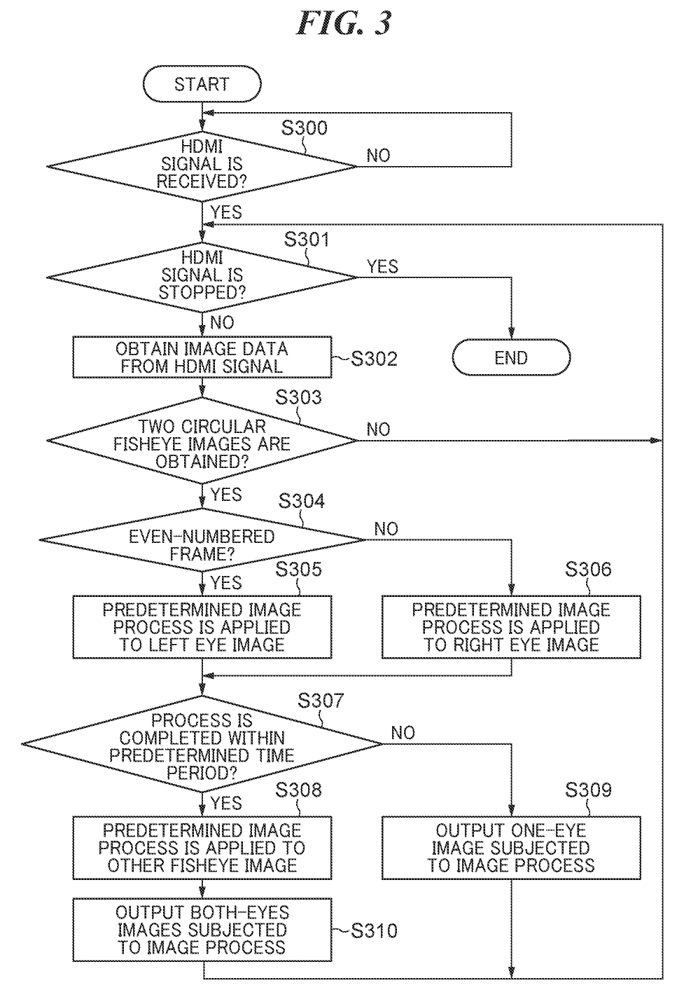

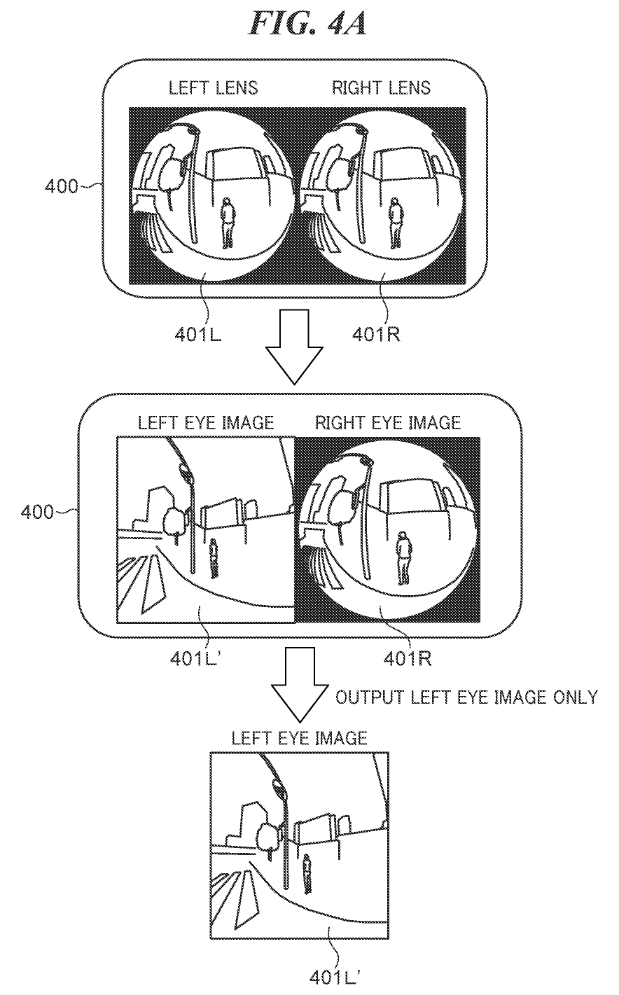

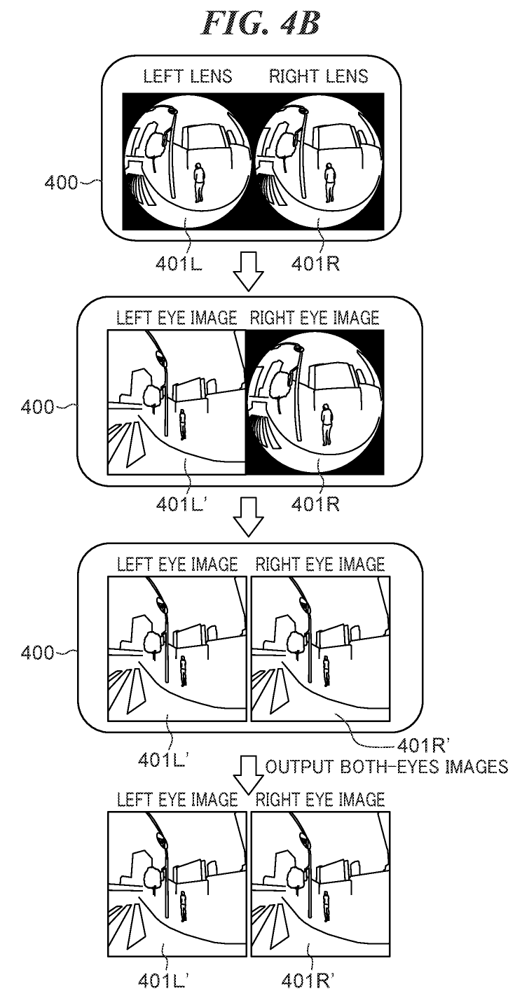

FIG. 3 is a flowchart illustrating a process executed by the image processing apparatus. FIG. 4A is a view for describing processes in steps S305 and S309 in the flowchart shown in FIG. 3. FIG. 4B is a view for describing processes in steps S308 and S310 in the flowchart shown in FIG. 3. As illustrated in FIG. 3, in a step S300, the controller 205 of the image processing apparatus 110 determines whether an HDMI signal output from the digital camera 100 is received with the external I/F 240.

As a result of the determination in the step S300, when the controller 205 determines that the HDMI signal is received, the process proceeds to a step S301. On the other hand, as a result of the determination in the step S300, when the controller 205 determines that the HDMI signal is not received, the process waits in the step S300.

In the step S301, the controller 205 determines whether the output of the HDMI signal from the digital camera 100 is stopped. As a result of the determination in the step S301, when the controller 205 determines that the output of the HDMI signal is stopped, the process ends. On the other hand, as a result of the determination in the step S301, when the controller 205 determines that the output of the HDMI signal is not stopped, the process proceeds to a step S302.

In the step S302, the controller 205 reads image data included in the HDMI signal received in the step S300. Then, when the data of the circular fisheye image is included in the image data, the controller 205 can obtain the circular fisheye image. In this way, in the present embodiment, the controller 205 functions as an obtaining unit that obtains a circular fisheye image. In the image processing apparatus 110, a part functioning as the obtaining unit may be provided separately from the controller 205.

In a step S303, the controller 205 determines whether the image data read in the step S302 includes the left eye image and the right eye image, which are the two circular fisheye images described above. In this way, in the present embodiment, the controller 205 functions as a determination unit that determines whether a left eye image and a right eye image are included. In the image processing apparatus 110, a part functioning as the determination unit may be provided separately from the controller 205. The determination in the step S303 is performed according to a known method using brightness of an image, for example. Then, as a result of the determination in the step S303, when the controller 205 determines that the left eye image and the right eye image are included, the process proceeds to a step S304. On the other hand, as a result of the determination in the step S303, when the controller 205 determines that the left eye image and the right eye image are not included, the process returns to the step S301 and the subsequent steps are sequentially executed. In this case, the image process described later is omitted.

In the step S304, the controller 205 determines whether the image data read in the step S302 is data of an even-numbered frame. As a result of the determination in the step S304, when the controller 205 determines that the frame is an even-numbered frame, the process proceeds to a step S305. On the other hand, as a result of the determination in the step S304, when the controller 205 determines that the frame is not an even-numbered frame, that is, the frame is an odd-numbered frame, the process proceeds to a step S306.

In the step S305, the controller 205 performs the image process (an image processing step) to reduce a distortion on the left eye image (one image) between the two circular fisheye images, which include the left eye image and the right eye image, determined to have been obtained in the step S303, and obtains a left eye image with a reduced distortion. In this way, in the present embodiment, the controller 205 functions as an image processing unit that executes the image process to reduce distortion of a circular fisheye image. In the image processing apparatus 110, a part functioning as the image processing unit may be provided separately from the controller 205.

A circular fisheye image 400 in FIG. 4A is an image captured by the digital camera 100 to which the lens unit 105 is attached. The circular fisheye image 400 includes a left eye image 401L formed by a left lens of the lens unit 105 and a right eye image 401R formed by a right lens of the lens unit 105. Then, in the step S305, an image conversion process based on an equirectangular projection is executed as an image process for the left eye image 401L. Accordingly, the left eye image 401L is converted into a distortion-reduced left eye image 401L'.

In the step S305, preferably, a parallax correction process of correcting the parallax between the left eye image and the right eye image is performed on the left eye image and the right eye image prior to the image process. This allows the user to view the image more stereoscopically on the HMD 120. The parallax correction process is executed, in consideration of an influence of a deviation between optical axes of the left lens and the right lens of the lens unit 105, on the basis of the individual difference, such as an assembly error of the lens unit 105, the meta information, such as a posture of the digital camera 100 in capturing an image and a temperature environment in capturing an image. In the parallax correction process, only when one of the left eye image and the right eye image is selected, the parallax correction of the one image may be performed while fixing the other image.

In the step S306, the controller 205 performs the image process to reduce a distortion on the right eye image (one image) among the images determined to include the left eye image and the right eye image in the step S303, similarly to the step S305 (the image processing step).

In a step S307, the controller 205 determines whether the image process in the step S305 or S306 has been executed and completed within a predetermined time period. In the present embodiment, as an example, 60 frames of images shall be received per second in the step S300. In this case, it is necessary to execute the image process in the step S305 or S306 within about 16 msec. In order to perform the image process on the left eye image and the right eye image within 16 msec under this condition, it is necessary to complete the image process on each image within 8 msec. Therefore, when the image process for one of the left eye image and the right eye image is completed within 8 msec, it is determined that the image process for the other image will be also completed within the remaining 8 msec (= 16 msec - 8 msec).

Then, as a result of the determination in step S307, when the controller 205 determines that the image process is completed within the predetermined time period (8 msec), the process proceeds to a step S308. On the other hand, as a result of the determination in the step S307, when the controller 205 determines that the image process is not completed within the predetermined time period (8 msec), the image process for the other image will not be in time, and the process proceeds to a step S309. Although the determination in the step S307 is configured to determine whether the process is completed within the predetermined time at the time point when the process for a one-eye image is completed in the present embodiment, this is not limited. For example, the determination in the step S307 may be configured to determine whether the process for both-eyes images has been completed at the time when a predetermined time has elapsed from the start of the process.

In the step S308, the controller 205 performs the image process to reduce a distortion on the other image (the image processing step). That is, the controller 205 performs the image process on the right eye image when the process proceeds via the step S305, and performs the image process on the left eye image when the process proceeds via the step S306. The image process for each image is similar to the image process in the step S305.

The circular fisheye image 400 in FIG. 4B is captured by the digital camera 100 to which the lens unit 105 is attached, similarly to FIG. 4A. The circular fisheye image 400 includes the left eye image 401L and the right eye image 401R. Then, in the step S305, the image process has been executed on the left eye image 401L. Accordingly, the left eye image 401L is converted into the distortion-reduced left eye image 401L'. In addition, in the step S308, the image conversion process based on the equirectangular projection is executed as the image process for the right eye image 401R. As a result, the right eye image 401R is converted into a distortion-reduced right eye image 401R'.

In the step S309, the controller 205 outputs the left eye image (one image) on which the image process has been executed in the step S305 or the right eye image (one image) on which the image process has been executed in the step S306 to the HMD 120 via the communication unit 235 (an output unit). FIG. 4A shows a state in which the left eye image 401L' is output.

In the step S310, the controller 205 outputs the image (one image) on which the image process is executed in the step S305 or the step S306 and the image (the other image) on which the image process is executed in the step S308 to the HMD 120 via the communication unit 235. FIG. 4B shows a state in which the left eye image 401L' and the right eye image 401R' are output.

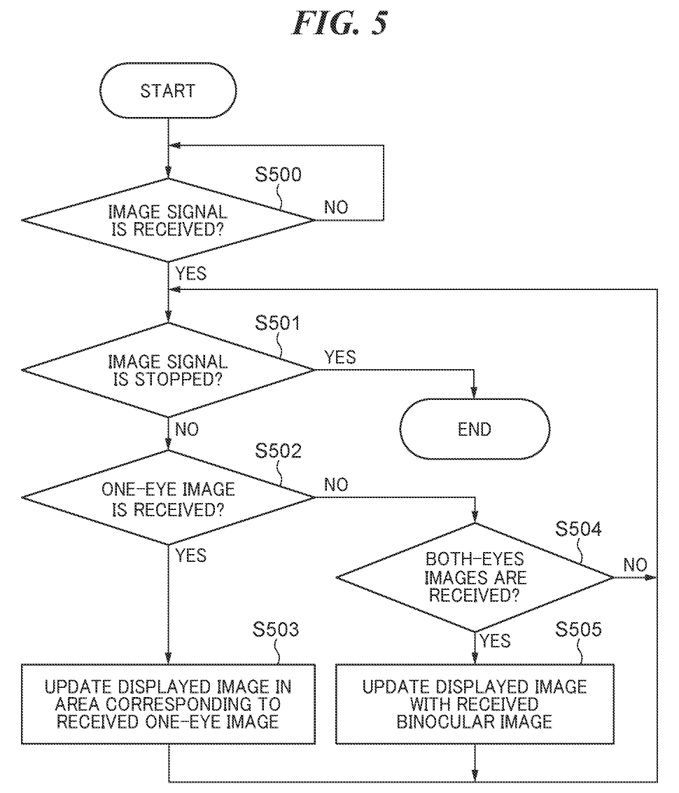

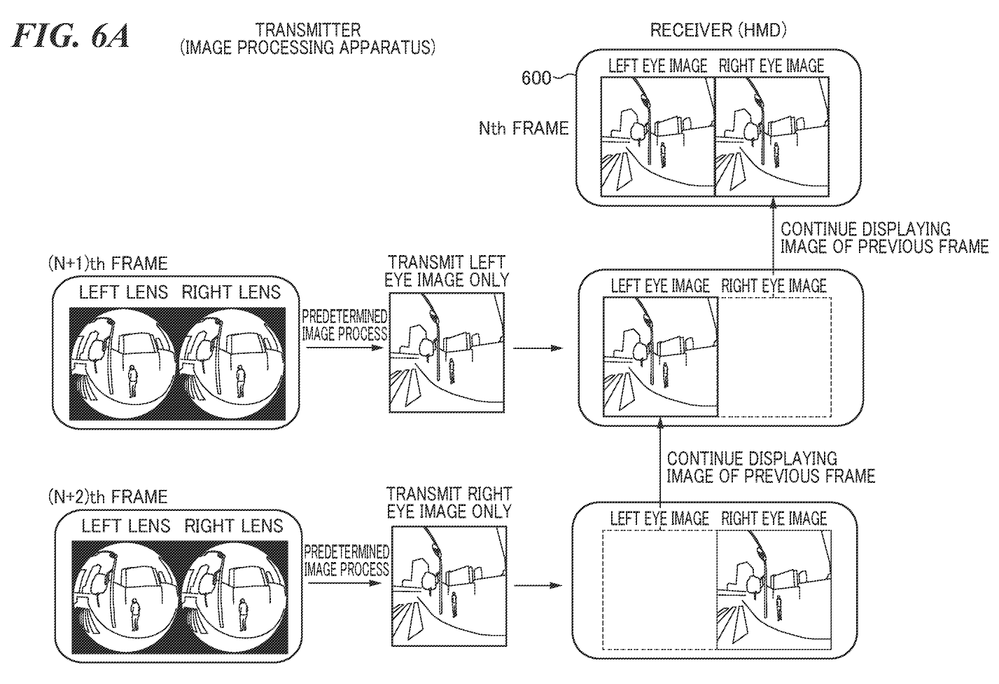

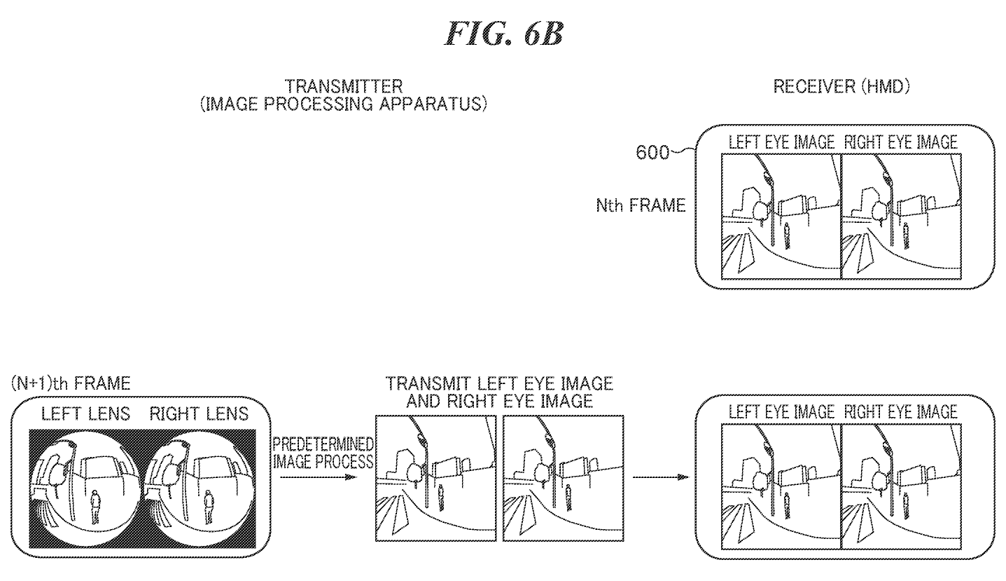

FIG. 5 is a flowchart illustrating a process executed by the HMD. FIG. 6A is a view for describing a process in a step S503 in the flowchart shown in FIG. 5. FIG. 6B is a view for describing a process in a step S505 in the flowchart shown in FIG. 5. As shown in FIG. 5, in a step S500, a controller of the HMD 120 (hereinafter referred to as an “HMD controller”) determines whether the image signal output from the communication unit 235 of the image processing apparatus 110 is received. The image signal includes the image output in the step S309 (see FIG. 3) or the images output in the step S310 (see FIG. 3).

Then, as a result of the determination in the step S500, when the HMD controller determines that the image signal is received, the process proceeds to a step S501. On the other hand, as a result of the determination in the step S500, when the HMD controller determines that no image signal is received, the process waits in the step S500.

In the step S501, the HMD controller determines whether the output of the image signal from the image processing apparatus 110 is stopped. As a result of the determination in the step S501, when the HMD controller determines that the output of the image signal is stopped, the process ends. On the other hand, as a result of the determination in the step S501, when the HMD controller determines that the output of the image signal is not stopped, the process proceeds to a step S502.

In the step S502, the HMD controller determines whether the circular fisheye image included in the image signal received in the step S500 is a left eye image or a right eye image, that is, a one-eye image (one image). As described above, in the present embodiment, the HMD controller functions as a determination unit that determines whether the circular fisheye image obtained by the HMD controller (an obtaining unit) is a one-eye image. In the HMD 120, a part functioning as the determination unit may be provided separately from the HMD controller. Then, as a result of the determination in the step S502, when the HMD controller determines that the one-eye image is received, the process proceeds to the step S503. On the other hand, as a result of the determination in the step S502, when the HMD controller determines that the received image is not a one-eye image, the process proceeds to a step S504.

In the step S503, the HMD controller updates the one-eye image being displayed on the HMD 120 with the one-eye image that is included in the image signal received in the step S500 and has been subjected to the image process. Note that this update is performed only on the region corresponding to the one-eye image included in the image signal received in the step S500. In addition, the region not corresponding to the one-eye image is continuously displayed as in the previous frame. In this way, in the present embodiment, the HMD controller functions as an update unit that updates an image. In the HMD 120, a part functioning as the update unit may be provided separately from the HMD controller.

A circular fisheye image 600 in FIG. 6A is an image (video) displayed on the HMD 120 in an Nth frame. For example, when only a left eye image that has been subjected to the image process is transmitted from the image processing apparatus 110 in an (N+1)th frame, the HMD 120 receives only the left eye image and updates the display to the left eye image concerned. On the other hand, the right eye image of the Nth frame is continuously displayed as the right eye image in the (N+1)th frame. Similarly, when only the right eye image that has been subjected to the image process is transmitted from the image processing apparatus 110 in an (N+2)th frame, the HMD 120 receives only the right eye image and updates the display to the right eye image concerned. On the other hand, as the left eye image in the (N+1)th frame is continuously displayed as the left eye image in the (N+2)th frame.

In the step S504, the HMD controller determines whether the circular fish eye image included in the image signal received in the step S500 includes both a left-eye image and a right-eye image, that is, both-eyes images. As a result of the determination in the step S504, when the HMD controller determines that the both eyes images are received, the process proceeds to the step S505. On the other hand, as a result of the determination in the step S504, the HMD controller determines that the both-eyes images are not received, the process returns to the step S501, and the subsequent steps are sequentially executed.

In the step S505, the HMD controller updates the both-eyes images being displayed on the HMD 120 to the both-eyes images that are included in the image signal received in the step S500 and have been subjected to the image process. The circular fisheye image 600 in FIG. 6B is an image displayed on the HMD 120 in the Nth frame, similarly to FIG. 6A. For example, when the both-eyes images that have been subjected to the image process are transmitted from the image processing apparatus 110 in the (N+1)th frame, the HMD 120 receives the both-eyes images and updates the display to the both-eyes images concerned. Although the update process in the steps S503 and S505 is executed by the HMD controller in the present embodiment, this is not limited. For example, the controller 205 (an update control unit) of the image processing apparatus 110 may execute the update process in the steps S503 and S505. This can reduce the processing load on the HMD 120.

As described above, in the image process system 1000, the fisheye image (moving image) captured by the digital camera 100 can be live streamed to the HMD 120 by the image processing apparatus 110 in real time. At this time, the image processing apparatus 110 can complete the image process for the left eye image and the right eye image in accordance with the frame rate at the time of streaming. In addition, the HMD 120 can update the image currently being displayed to the image that has been subjected to the image process in the image processing apparatus 110, that is, the image processed image. Accordingly, the user can observe the smooth live streaming moving image on the HMD 120.

According to the present disclosure, it is possible to complete the image process in accordance with a frame rate at the time of streaming.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-166161, filed September 25, 2024 which is hereby incorporated by reference herein in its entirety.

What is claimed is:

1. An image processing apparatus communicably connected to a display device that displays a left eye image viewable by a left eye and a right eye image viewable by a right eye, the image processing apparatus comprising:
a memory device that stores a set of instructions; and
at least one processor that executes the set of instructions to:
obtain a fisheye image that is a moving image captured using a fisheye lens;
perform an image process to reduce a distortion on one image between a left eye image and a right eye image in a case where the fisheye image includes the left eye image and the right eye image; and
perform the image process on another image in a case where the image process for the one image is completed within a predetermined time period.

2. The image processing apparatus according to claim 1, wherein the at least one processor executes instructions in the memory device to:
determine whether the acquired fisheye image includes the left eye image and the right eye image;
perform the image process on the one image in a case where it is determined that the fisheye image includes the left eye image and the right eye image as a result of the determination;
perform the image process on the other image in a case where the image process for the one image is completed within the predetermined time period;
omit the image process in a case where it is determined that the fisheye image does not include the left eye image and the right eye image.

3. The image processing apparatus according to claim 2, wherein the at least one processor executes instructions in the memory device to perform a process to correct parallax between the left eye image and the right eye image on the left eye image and the right eye image in the case where it is determined that the fisheye image includes the left eye image and the right eye image as a result of the determination.

4. The image processing apparatus according to claim 1, wherein the at least one processor executes instructions in the memory device to output the one image that has been subjected to the image process and the other image that has been subjected to the image process to the display device in the case where the image process has been performed on the other image.

5. The image processing apparatus according to claim 4, wherein the at least one processor executes instructions in the memory device to output the one image that has been subjected to the image process to the display device in a case where the image process for the one image is not completed within the predetermined time period.

6. The image processing apparatus according to claim 1, wherein the at least one processor executes instructions in the memory device to perform the image process on the left eye image in a case where the fisheye image is an even-numbered frame and perform the image process on the right eye image in a case where the fisheye image is an odd-numbered frame in performing the image process on the one image.

7. The image processing apparatus according to claim 1, wherein the at least one processor executes instructions in the memory device to allow execution of a conversion process based on an equirectangular projection, as the image process to the fisheye image.

8. The image processing apparatus according to claim 1, wherein the fisheye image is a circular fisheye image.

9. The image processing apparatus according to claim 1, wherein the at least one processor executes instructions in the memory device to:
allow control of updating the fisheye image displayed on the display device; and
update the one image currently being displayed to the one image that has been subjected to the image process in a case where the fisheye image includes the one image that has been subjected to the image process.

10. A display device that is communicatively connectable to an image processing apparatus, the display device comprising:
a memory device that stores a set of instructions; and
at least one processor that executes the set of instructions to:
obtain a fisheye image, which is a moving image captured using a fisheye lens, from the image processing apparatus;
display the fisheye image obtained;
update the one image currently being displayed to the one image that has been subjected to an image process to reduce a distortion in a case where the fisheye image includes the one image that has been subjected to the image process.

11. The display device according to claim 10, wherein the at least one processor executes instructions in the memory device to:
determine whether the fisheye image obtained includes the one image that has been subjected to the image process; and
update the one image currently being displayed to the one image that has been subjected to the image process in a case where the fisheye image includes the one image that has been subjected to the image process as a result of the determination.

12. The display device according to claim 10, wherein the display device is a head mounted display.

13. A control method for an image processing apparatus communicably connected to a display device that displays a left eye image viewable by a left eye and a right eye image viewable by a right eye, the control method comprising:
obtaining a fisheye image that is a moving image captured using a fisheye lens;
performing an image process to reduce a distortion on one image between a left eye image and a right eye image in a case where the left eye image and the right eye image are included in the fisheye image; and
performing the image process on another image in a case where the image process for the one image is completed within a predetermined time period.

14. A non-transitory computer-readable storage medium storing a control program causing a computer to execute the control method according to claim 13.
